(19) United States
(12) Patent Application Publication
(10) Pub. No.: US 2009/0188925 A1
(43) Pub. Date: Jul. 30, 2009

(54) Pot set and a lid-like arrangement connected thereto

(75) Inventor: Peter Ek, Jarfalla (SE)

Correspondence Address: Groth & Co KB, Box 6107, Stockholm, SE-102 32, omitted

(73) Assignee: OBH Nordica Holding A/S, Taastrup (DK)

(21) Appl. No.: 12/114,841

(22) Filed: May 5, 2008

(30) Foreign Application Priority Data
Jan. 28, 2008 (SE) 0800213-1

(51) Int. Cl. A47J 36/06; A47J 27/00; A47J 36/08; B65D 45/14

(52) U.S. Cl. 220/573.1; 220/318; 220/293

(57) ABSTRACT

A lid-like arrangement can be useable with a first unit such as a pot or frying pan set. The lid-like arrangement can consist of an upper portion and a rim terminally extending around the upper portion, wherein the rim is arranged to be easily connectable and easily separably cooperable with an open upper section of the first unit. The rim can be formed as two rim portions connectable with each other, in cross-section angle formed rim portions, formed as an inner first rim portion and an outer rim portion, such that the rim portions are connected and/or joined to one another. Oppositely-directed outward surface extensions, for the inner rim portion and outer rim portion, can be arranged to support the upper portion between them.

### TECHNICAL FIELD OF THE INVENTION

The present invention generally relates in part to a pot and in part to a lid-like arrangement connectable thereto.

The goal of the pot set is to more particularly offer a pot set easier to use within a kitchen environment, which is specially designed for and arranged to be manoeuvrable to different adjustable positions by using a graspable and/or graspable handle(s).

Such a pot set allows the use of two separate units, but easily connectable and separable from one another, where:
a. a first unit, in the form of a pot or the like provided with an open upper section, is arranged to be capable of containing an amount of a chosen pourable, such as fluid-like, volume and
b. a second unit, in the form of a lid or a lid-like arrangement cooperable with said first unit's open upper section, is provided with a circumferential rim or cant to cooperate with said open upper section such that this second unit is rotatably related to said first unit or vice versa in a plane of the unit, to be able to lead to different positions with each other.

More specifically, the present invention relates to a pot set where said first unit is provided, in this case, a handle, with a handle-related first part, attached to the outside of said first unit, and a second part, provided as, for a one hand arrangement, a grip-suited part fixed to the side of said first unit, and where said second unit is arranged, in this case, a handle, with a handle-related first part attached to the side of said second unit and a second part, fixed to the side of said second part.

More particularly it is a question of allowing the first unit's open upper section to be arranged with a lip-formed dip, recess, or the like, to allow for a controlled passage of the pourably-arranged volume contained in the first unit, with a rotation of the first unit and its open upper section with associated second unit via this handle from a horizontal or substantially horizontal position.

Said second unit shall be provided with a rim extending around or terminally extending, with, in this case, a recess provided in said rim within a defined rim portion or portion thereof.

Said second unit, with its provided rim, is displaceable or rotatable relative to said first unit and its open upper section to and from such a position that the second unit's handle finds itself in a position aligned with the first unit's handle, when said recess, cooperating with the second unit, leads to an indicated position with the first unit's said lip formed depression or the like.

The invention even comprises a lid-like arrangement, such as an arrangement useable with different pot sets, which shall contain a transparent upper portion and a circumferential rim for the upper portion, where this rim is arranged to be easily connectable and easily separable in cooperation with an open upper section for a first unit, in the form of a pot, a double boiler, a frying pan or the like.

The following description defines;
a. a heating position as a position where the first part with an applied second part leads to an aligned position with each other and where the first part rests near a heat source and where the first part's handle and the second part's handle lead to a vertical angled position with each other to see to it that a recess and a dip are orientated from an indicated position,
b. an emptying- or draining position; like a position from a cooking position's vertical angled position, yet the first part with an applied second part together lead to a coordinated position with each other and where the first part's handle and the second part's handle lead to a coordinated and parallel position with each other, to in this position be able to separate and drain the fluid-like contents from more solid portions or substances,
c. a cooking position; where the first part with and applied second part lead to an aligned position with each other and where the first part rests upon a heat source and where the first part's handle and the second part's handle lead to a vertical angled position with each other to allow that a recess and a dip are located from a indicated position and where the fluid-like contents are covered by the second part and where said second part is, from a steam pressure building within, arranged to raise itself relative to the first part's open upper section and allow a produced steam stream to thus pass an exposed recess which on that occasion partially extends over the open part of the rim or cant.

The first part and the second part can preferably demonstrate a circular cross-section.

The invention further builds on an involved dip, or opposing dips, shall be oriented at or about 90° with an outward extension of a handle so that during a tilting of the first part and the second part pour out a portion of the fluid-like contents.

A pot set as described herein may suitably be used for right-handed individuals as well as left-handed, especially with opposing dips.

### BACKGROUND OF THE INVENTION

Methods, arrangements and constructions related to the above-described technical field and nature are previously known in a plurality of different embodiments.

The present invention relates to a direct further development of the pot set which is more closely shown and described in the patent publication U.S. Pat. No. 2,083,017.

The contents in the patent publication U.S. Pat. No. 2,083,017, and their function and nature will be more closely described in the following and in connection to an attached FIG. 1.

In said patent publication it allows the use of two separate, although easily connectable and separable from each other units, where;
a. a first unit, in the form of a pot or the like provided with an open upper section, is arranged to be capable of containing an amount of a chosen pourable, such as fluid-like, volume and
b. a second unit, in the form of a lid or a lid-like arrangement cooperable with said first unit's open upper section, is provided with a circumferential rim or cant to cooperate with said open upper section such that this second unit is rotatably related to said first unit or vice versa in a plane of the unit.

More particularly the present invention relates to such a pot set where said first unit is provided with, in this case, a handle, a handle-related first part, attached to the outside of said first unit, and a second unit, provided as, for a one hand arrangement, a grip-suited part fixed to the side of said first unit, and where said second unit is arranged, in this case, a handle, with a handle-related first part attached to the side of said second unit and a second part, fixed to the side of said second part.

Said first unit's open upper section is organised as a lip-formed dip or the like to allow for a controlled passage of the pourably-arranged volume contained in the first unit, with a rotation of the first unit and its open upper section with associated second unit via this handle from a horizontal or substantially horizontal position

Said second unit shall be provided with an extending around or terminally extending rim with, in this case, a recess provided in said rim within a defined rim portion or portion thereof.

Said second unit, with it's rim, is displaceable or rotatable relative to said first unit and it's open upper section to and from such a position that the second unit's handle finds itself in an aligned position with the first unit's handle, where said recess provided to the second unit leads to an indicated position with said dip or the like in the first unit.

Regarding the present invention, as it is structured above, in the form of a lid-like arrangement, it can be mentioned that there is a cant to cover an upper open part for a first unit with a lid, which in the form of a single unit is made from a metal material o'r a glass material, such as hardened glass material.

There have also been proposed different lid-like arrangements, which are useable with different pot sets and which comprise a transparent upper portion and a terminally extending rim portion, where the rim portion is arranged to be easily connectably and easily separably coordinated with an open upper section for a first unit, in the form of a pot, a double boiler, or the like.

Further known technology relates to this technical field and to that which the present invention relates to, is shown and described in, among others, the following patent publications; U.S. Pat. No. 5,730,045, U.S. Pat. No. 5,653,881 and U.S. Pat. No. 4,310,418.

### SUMMARY OF THE PRESENT INVENTION

### Technical Problem

Considering the circumstance that the technical considerations which a skilled person in the art must make to offer a solution to one or more postulated technical problems it is initially an essential insight in the measure and/or the sequence of measures which shall be taken, partially an essential choice of the material(s) which are required so should, be relevant for delivering the present inventive steps on account of the following technical problems.

Considering the earlier state of the art, such as apparent in the patent publication given in the introduction, and which more closely are defined with the preamble in following patent claim 1, it should be seen that a technical problem lies in the ability to understand the significance of, the benefits associated with and/or the technical measures and consideration which is required to allow the second part provided to the second unit to be arranged as a, for one hand arrangement, graspable or grip-suited part, so that in a relatively aligned rotational position, where one or more recesses lead to an indicated position with one or more recesses, where the first unit's grip-suited second part can lead to an aligned position with the second unit's grip-suited second part.

A technical problem lies in the ability to understand the significance of, the benefits associated with and/or the technical measures and consideration which is required to allow the two second parts to be provided coordinated lengths, which connect to, or in this case essentially connect directly to, one another.

A technical problem lies in the ability to understand the significance of, the benefits associated with and/or the technical measures and consideration which is required to allow a first surface section of the grip-suited second part provided to the first unit to be arranged to cooperate with and/or sealingly connect itself to, the second surface section of the grip-suited second part provided to the second unit to allow both of said parts, in a coordinated position, to build together a graspable and grip-suited handle, where an applied grasping force created by one hand shall be arranged to allow the bringing together of said surface sections toward one another with friction

A technical problem lies in the ability to understand the significance of, the benefits associated with and/or the technical measures and consideration which is required to allow the second units handle-related first part to be provided with a mechanical strengthening at its connection via a rim part to the second unit.

A technical problem lies in the ability to understand the significance of, the benefits associated with and/or the technical measures and consideration which is required to allow said strengthening to primarily be provided to said first units upper part.

A technical problem lies in the ability to understand the significance of, the benefits associated with and/or the technical measures and consideration which is required to allow said first surface portion and said second surface portion to be provided an angle of between 5 and 15°, such as 6 to 10°, upward, in relation to a virtual plane oriented within the upper open part.

A technical problem lies in the ability to understand the significance of, the benefits associated with and/or the technical measures and consideration which is required to allow said grip-suited parts to show a heat insulating portion, such as a silicone portion.

A technical problem lies in the ability to understand the significance of, the benefits associated with and/or the technical measures and consideration which is required to allow a recess provided to the second unit and the dip provided to the first unit to be duplicated and directly opposite or in this case essentially directly oppositely oriented, such as diametrically or in this case essentially diametrically oriented.

A technical problem lies in the ability to understand the significance of, the benefits associated with and/or the technical measures and consideration which is required to allow an upper support port provided to the first unit to be arranged to sealingly support a terminally extending first part provided to the second unit, within a rim portion or a cant.

A technical problem lies in the ability to understand the significance of, the benefits associated with and/or the technical measures and consideration which is required to allow a second part provided to the second unit, arranged to extend a bit into said frost unit and through said open part, to be arranged to create a narrow “sealing” gap there for steam under pressure between said second part and an inner surface section of said first unit, located adjacent to said open part.

A technical problem lies in the ability to understand the significance of, the benefits associated with and/or the technical measures and consideration which is required to allow a cross-section surface, created between said second part's provided free cant and adjacent to a cant oriented to the first part to be arranged to somewhat extend over the cross-section surface of the open part to forcibly control and displace the second part within the open part.

A technical problem lies in the ability to understand the significance of, the benefits associated with and/or the technical measures and consideration which is required to allow said recess or recesses to be provided said second part and leave a portion of the rim portion without deformation adjacent to its free cant, where this part is arranged for an orientation under said dip for a sealing, via a narrow “sealing” gap, toward an inner surface section for said first unit.

A technical problem lies in the ability to understand the significance of, the benefits associated with and/or the technical measures and consideration which is required to allow the rim portion provided to said second unit to be formed as two rim portions cooperable with each other in cross-section right angle, or essentially right angle formed, where the inner rim portion is formed with said recess(es) and where a further part is formed with a support cant, arranged as a support toward the upper open part provided to the first unit.

A technical problem lies in the ability to understand the significance of, the benefits associated with and/or the technical measures and consideration which is required to allow the rim, with its outer rim portion, to be provided with a peripheral outward extension for the upper surface part provided to said rim portion in relation to the second units surface extension within a relationship of 0.1 to 0.4.

A technical problem lies in the ability to understand the significance of, the benefits associated with and/or the technical measures and consideration which is required to allow said recess provided to the second unit to be formed exclusively within and surrounded by said inner part.

A technical problem lies in the ability to understand the significance of, the benefits associated with and/or the technical measures and consideration which is required to allow the first unit and the second unit to each be provided with corresponding circular cross-sections.

A technical problem lies in the ability to understand the significance of, the benefits associated with and/or the technical measures and consideration which is required to allow a chosen distance, between the rim's and the outer rim's upper surface and a lower cant's outward extension for the inner rim portion, to be arranged at a value of between 0.1 and 0.2, such as about 0.15, to be related to the outer diameter provided for the outer rim portion.

A technical problem lies in the ability to understand the significance of, the benefits associated with and/or the technical measures and consideration which is required to allow a centrally located horizontal part in the form of a glass part provided to the second unit, to be attached or pressed between said two rim portions.

A technical problem lies in the ability to understand the significance of, the benefits associated with and/or the technical measures and consideration which is required to allow said recess, within said second unit and an inner portion associated with the unit to be formed as a sieve structure.

A technical problem lies in the ability to understand the significance of, the benefits associated with and/or the technical measures and consideration which is required to allow that the handle provided to the first unit and the handle provided to the second unit to be provided the same lengths and/or an outward convergence for corresponding forms arranged for one hand.

A technical problem lies in the ability to understand the significance of, the benefits associated with and/or the technical measures and consideration which is required to allow the handle provided to or cooperable with the first unit and the handle provided to or cooperable with the second unit to demonstrate to one another sealingly associable plane or essentially plane, and equally extending surface sections.

A technical problem lies in the ability to understand the significance of, the benefits associated with and/or the technical measures and consideration which is required to allow a length provided to the recess, along a cant portion for the inner rim portion, and a length provided a lip-formed dip, along the open upper portion provided to the first unit, to be arranged similarly.

A technical problem lies in the ability to understand the significance of, the benefits associated with and/or the technical measures and consideration which is required to allow said handles, provided to the first and second units, to be provided a grip-suited and graspable part formed as a small angle.

A technical problem lies in the ability to understand the significance of, the benefits associated with and/or the technical measures and consideration which is required to allow a first handle related's first part for a first handle and a second handle related's first part to be opposingly oriented to said first and second units respectively.

A technical problem lies in the ability to understand the significance of, the benefits associated with and/or the technical measures and consideration which is required to allow the opposing orientation to be chosen to connect to the orientation of a chord provided to a circle line, chosen with a circular measure between 160° and 140°.

A technical problem lies in the ability to understand the significance of, the benefits associated with and/or the technical measures and consideration which is required to allow the first unit's first and second parts to demonstrate an outwardly aligned is converging form, with convergence of between (1-3):30, such as 1:20.

A technical problem lies in the ability to understand the significance of, the benefits associated with and/or the technical measures and consideration which is required to allow the second unit's first and second parts to demonstrate an outwardly aligned converging form, with convergence of between (1-3):30, such as 1:20.

A technical problem lies in the ability to understand the significance of, the benefits associated with and/or the technical measures and consideration which is required so that the first unit's first part shall demonstrate an underlying reinforcement.

A technical problem lies in the ability to understand the significance of, the benefits associated with and/or the technical measures and consideration which is required to allow the first unit's transition between its reinforcement and its second part and the second unit's transition between its reinforcement and its second part may demonstrate a thickness ratio of between (2.5-1.5):1, such as preferably 2:1.

Considering the earlier state of the art, regarding lid-like arrangements, which are described above, it should be seen that a technical problem lies in the ability to understand the significance of, the benefits associated with and/or the technical measures and consideration which is required to allow such a lid-like arrangement to be formed from a few, easily produceable and easily assembled parts from different materials.

A technical problem lies in the ability to understand the significance of, the benefits associated with and/or the technical measures and consideration which is required to allow said rim portion to be formed as two rim portions connectable to each other, in cross section to a right, or in this case principally right angle formed rim portions, with an inner rim portion and an outer rim portion integratably formed or joined with each other.

A technical problem lies in the ability to understand the significance of, the benefits associated with and/or the technical measures and consideration which is required to form virtually or actually oppositely-directed surface extensions for the inner rim portion and the outer rim portion, so that these are arranged to support said trans-parent over portion.

A technical problem lies in the ability to understand the significance of, the benefits associated with and/or the technical measures and consideration which is required to form the inner rim portion's oppositely-directed surface extensions as a specially formed holding device for said transparent upper part.

A technical problem lies in the ability to understand the significance of, the benefits associated with and/or the technical measures and consideration which is required to form the outer rim portion's oppositely-directed surface extensions and the inner rim portion's oppositely-directed extensions to form said holding device as a channel provided to the rim portion, arranged to cooperate with and support a peripheral cant portion provided to the transparent upper portion.

A technical problem lies in the ability to understand the significance of, the benefits associated with and/or the technical measures and consideration which is required to for a downward portion provided to the inner rim portion to demonstrate, in connection with its' cant extension, one or several recesses with a sieve structure.

A technical problem lies in the ability to understand the significance of, the benefits associated with and/or the technical measures and consideration which is required to form the outer rim portion's downward portion so that it demonstrates a cant extension, useable as a support cant by one open upper portion provided to the first unit.

### The Solution

The present invention starts then from the introductorily referred to prior art and builds on a pot set, according to the introduction to patent claim 1, and a lid-like arrangement according to the introduction to patent claim 28.

Where it regards the pot set the present invention builds on such an arrangement which allows use of two separate, although easily connectable and separable from one another units, where;
a. a first unit, in the form of a pot or the like provided with an open upper section, is arranged to be capable of containing an amount of a chosen pourable, such as fluid-like, volume and
b. a second unit, in the form of a lid or a lid-like arrangement cooperable with said first unit's open upper section, is provided with a circumferential rim or cant to cooperate with said open upper section such that this second unit is rotatably related to said first unit or vice versa in a plane of the unit.

More particularly the present invention relates to a pot set where said first unit is provided, in this case, a handle, a handle-related first part, attached to the outside of said first unit, and a second part, provided as, for a one hand arrangement, a grip-suited and graspable part fixed to the side of said first unit, and where said second unit is arranged, in this case, a handle, with a handle-related first part attached to the outside for said second unit and a second part, arranged to be side oriented said second part.

Said first unit's open upper section shall be provided with a lip-formed dip of the like, the therewith allow for a controlled passage of the pourably-arranged volume contained in the first unit, with a rotation of the first unit and its open upper section with associated second unit via this handle from a horizontal or essentially horizontal position.

Said second unit shall be provided with a rim extending around or terminally extending, with, in this case, a recess provided in said rim within a defined rim portion or portion thereof.

Said second unit, with its provided rim, shall here be displaceable or rotatable relative to said first unit and its open upper section to and from such a position that the second unit's handle finds itself in a position aligned with the first unit's handle, when said recess, cooperating with the second unit, leads to an indicated position with the first unit's said lip formed depression or the like.

In order to solve one or more of the above-noted technical problems involves more specially said unit's associated second part shall be arranged, for a one hand arrangement, as one grip-suited and graspable part, that in a coordinated relative rotational position, where said recess leads to an indicated position with said dip, the first unit's grip-suited and graspable second part leads to a coordinated position with the second unit's grip-suited and graspable second part, that said second parts are provided with coordinated lengths which connect to, or in this case essentially connect to, each other, that the first unit's provided grip-suited and graspable second part, provided on a first surface section, is arranged to cooperate with and/or sealingly connect itself to one second surface section of the second unit's provided grip-suited graspable second part, and that both of said second parts together, in a coordinated position, form a graspable handle where an applied grasping power is arranged to bring together said surface sections towards one another.

Furthermore the present invention involves that the second unit's handle-related first part, at its connection to the second unit, shall be provided with reinforcement.

Said reinforcement is provided to said first part's upper portion.

Said first surface section and said second surface section should be cooperable with an angle between 5 and 15°, such as 6 to 10°, upwards, in relation to a plane oriented within the open upper section.

Said grip-suited parts should show a heat insulating portion, such as a silicone portion.

More specifically, the present invention involves that said recess provided to the second unit and said dip provided to said first unit, shall be doubled and directly opposite, or in this case essentially directly opposite, such as diametrically or in this case essentially diametrically oriented.

It particularly involves that the upper supporting part provided to the first unit shall be arranged to sealingly support a terminally extending first rim portion provided to the first unit, within a rim.

A rim portion provided to the second unit is provided and arranged to extend a bit in said first unit and through said open part and is arranged to there form a narrow gap, between said second rim portion and a inner surface section for said first unit, located adjacent to said open part.

A cross-sectional surface, created between a free cant provided to said second rim portion and a cant oriented adjacent to the first part, should be arranged to somewhat extend over the cross-sectional surface provided to the open part.

Said recess or recesses shall be provided to said second rim portion and leave a part of the rim portion without deformation adjacent to its free cant, where this portion is arranged for an orientation under said dip for a sealing, via a narrow gap, toward the inner surface section for said first unit.

The rim portion provided to said second unit should be formed as two rim portions aligned to one another, in a straight, or essentially straight angle-formed in cross-section, where the inner rim portion is formed with said recess (recesses) and where an outer rim portion can be formed with a supporting cant, arranged for a support toward the open upper portion provided to the first unit.

The rim portions, with its outer rim portion, is provided a peripheral extension for said upper surface portion provided to the rim portion, in relation to the second unit's surface extension falling within a ratio 0.1 to 0.4.

Said recess provided to the second unit shall be formed exclusively within and surrounded by said inner part.

The first unit and the second unit are preferably each provided with corresponding circular cross-sections.

A chosen distance between the rim portions and the outer rim portion's upper surface and a lower cant extension for the inner rim portion, is arranged to a value of between 0.1 and 0.2, such as about 0.15, to be related to an outer diameter provided to the outer rim portion.

A centrally oriented plan portion provided to the second unit, in the form of a glass part, is attached to or pressed between said two rim portions.

It is particularly noted that said recess, within said second unit and a unit-cooperable inner portion shall be formed as a sieve structure.

The handle provided to the first unit and the handle provided to the second unit are preferably provided the same length and/or outwardly converging corresponding forms arranged for one hand's grasp.

The handle provided to or cooperable with the first unit and the handle provided to or cooperable with the second unit demonstrate toward one another sealingly associable plane, or essentially plane, and similarly outwardly-extending surface sections.

A length provided to the recess, along a cant portion for the inner rim portion, and a lip-formed dip's provided length, along the open upper section provided to the first unit should be arranged similarly.

Said handles, provided to the first unit and the second unit, are provided a grip-suited and graspable part formed to a small angle.

A first handle-related first part, for a first handle and a second handle-related first part, for a second handle, can be oriented opposite to said first and said second units, respectively.

The opposing orientation is chosen to connect to the orientation of a chord provided to a circular line, chosen with a circular measure between 160° and 140°.

It is particularly noted that the first unit's first and second parts shall demonstrate an outwardly-aligned converging form, with a convergence of between (1-3):30, such as about 1:20.

The second units first and second parts shall demonstrate an outwardly-aligned converging form of between (1-3):30, such as about 1:20.

The first unit's first part shall also show an underlying reinforcement.

The first unit's transition between its reinforcement and its second part and the second unit's transition between its reinforcement and its second part demonstrate a thickness ratio of between (2.5-1.5):1, such as preferably 2:1 and where their free ends also demonstration the same ratio.

Where the lid-like arrangement is concerned the invention builds on an arrangement, which is useable with a first unit, such as different pot or frying pan sets, in the form of a second unit and consisting of a transparent upper portion and a upper portion's terminally extending rim portion, wherein said rim portion is arranged to be easily connectably and easily separably capable of cooperation with an open upper section for said first unit.

Herein it is proposed that said rim portion shall be formed as two rim portions cooperable with one another, right angle or in this case essentially right angle-formed in cross section with an inner rim portion and an outer rim portion aligned with one another, and that oppositely-aligned outward surface extensions, for the inner rim portion and the outer rim portion shall be arranged to support said transparent upper portion.

Such proposed embodiments, falling within this inventive thought, involves that the inner rim portion's oppositely-directed outer surface extensions shall be formed as a holding device for said transparent upper portion.

Further it allows that the outer rim portion's oppositely-directed outer surface extensions and the inner rim portion's oppositely-directed outer surface extensions shall cooperatively form a channel provided to the rim portion, arranged to cooperate with and support the transparent upper portion via a peripheral cant portion provided to the upper portion.

The inner rim portion's downwardly-aligned portion shall then demonstrate in connection to its cant extension, one or more recesses, preferably with a sieve structure.

Further it allows that the outer rim portion's downwardly-aligned portion shall demonstrate a cant extension, useable as a support cant toward an open upper section provided to the first unit.

More specifically, it allows that the transparent upper portion shall be formed of hardened glass material and that in this case one of the two rim portions shall be formed from a stainless steel material or the like.

Said recesses shall further be dimensioned to be able to register directly toward a lip-formed dip, located within the first unit's open upper section.

### Benefits

The benefits which can be foremost regarded as characteristic for the present invention and the, by that means, specially significant involved distinguishing features are, that herewith there has been created conditions to, with a pot set and a lid-like arrangement coordinated therewith, create a fast and effective manufacture of the separate parts and therein offer that the thus manufactured parts can cooperate with each other via inner and outer rim portions.

More specifically it allows that grip-suited and graspable handles, one attached to the one unit and one attached to the other unit, are arranged to separably be able to manoeuvre the one unit or the other unit and where these unit's handles lead to a sealingly aligned position a single grip-suited and graspable handle is created so that via such a handle to simplify an emptying of the first unit's viscous or watery contents and limit steam escape, primarily to the region in front of the aligned handles and their position.

In an emptying- or draining position for the pot set with boiling water, the water passes a first connection of a recess and a dip such that steam remains within the first unit, where the draining water creates an air current into the first unit via an opposing connection of recess and a dip.

That which can foremost be seen to be characterising of the present invention is given for a pot set in the following patent claim 1's characterised in that portion, and for a lid-like arrangement in the following patent claim 28's characterised in that portion.

### BRIEF DESCRIPTION OF THE FIGURES

Prior art, according to the American patent documents named in the introduction, and a number of presently proposed embodiments, demonstrating the significant characteristics connected with the present invention, shall now be more closely described for the purposes of example, with reference to the enclosed drawings, where;

FIG. 1 shows in a side view the FIG. 1 in the American patent document U.S. Pat. No. 2,083,017 given in the introduction,

FIG. 2 shows, in a perspective view, a first embodiment of a pot set with handle making use of two separate units, easily connectable with and easily seperable from each other, a first unit formed like a pot, and a second unit formed as a lid or a lid-like arrangement and where the pot set is illustrated in an emptying or suitably liquid draining position, an emptying or draining position alternatively a boiling position, with aligned and parallely oriented handles,

FIG. 3 shows, similarly in a perspective view, the set according to FIG. 2, in a position suited for boiling of a fluid-like volume, a boiling position, with the two handles somewhat displaced to the side for a sealing of a recess provided to the second unit, via a side part for the first unit,

FIG. 4 shows in a cross-section a construction for a connection between said first unit and said second unit, where said connection occurs between the first part's open upper portion and the second unit's rim with its rim portions, and where selected provided construction details are clearly made to illustrate them with the invention's lid-like arrangement's distinguishing features,

FIG. 5 shows, in a perspective view, a second embodiment, with oppositely-directed paired handles, for a pot set useable within a kitchen environment, making use of two separate units easily connectable to and easily separable from one another, a first unit formed as a pot and a second unit formed as a lid, and where the set is illustrated in an emptying or suitably liquid draining position, an emptying or draining position alternatively a boiling position, with aligned and diametrically oriented handles,

FIG. 6 shows, similarly in perspective view, the pot set according to FIG. 5, in a position suited for boiling of a fluid-like volume, a emptying or draining position alternatively a boiling position, with the handles displaced somewhat to the side,

FIG. 7 shows, in a plan view, the pot set in a positioning according to FIG. 5 and

FIG. 8 shows solely in side view and with some details enlarged a third embodiment of a pot set with a lid arrangement.

### DESCRIPTION OF DIFFERENCE FROM PRIOR ART IN CONNECTION TO THAT SHOWN AND DESCRIBED IN THE PATENT PUBLICATION U.S. Pat. No. 2,083,017

Thus it is shown in FIG. 1 a side view of a pot set useable within a kitchen environment, where this pot set allows the use of two separate, although easily connectable to and easily separable from one another, units, where;
a. a first unit, in the form of a pot (e) or the like is arranged to be capable of containing an amount of a chosen pourable, such as fluid-like, volume while
b. a second unit, in the form of a lid (a) cooperable with the first unit's open upper section, formed in a single material,
   where said first unit (e) is provided, in this case, a handle, with a handle-related first part, attached to the outside of said first unit (e), and a second part, arranged as a, for a one hand arrangement, a side oriented said first unit oriented grip-suited long part.

Said second unit (a) is provided, in this case, a handle (b), with a short, more inch related first part, attached to the outside of said second unit (a) and a second short part, arranged as a part side-oriented to said second unit for a rotation of the second unit's parts.

Said first unit's (e) open upper section is provided a lip (d) formed dip or the like, to therewith allow a controlled passage of the fluid-like volume contained in the first unit, with a rotation of the first unit (e) and its open upper section with the associated applied second unit (a) via its handles (f, b).

Said second unit (a) is provided with a recess (c) provided a rim portion and within a defined part thereof, wherein dais second unit (a) with its provided rim portion, is displaceable or rotatable relative to said first unit (e) and its open upper portion to such a position that the second unit's handle (b) finds itself in a coordinated position with the first unit's handle (f), where said recess (c) provided to the second unit leads to an indicated position with said dip or the like.

More specially this known pot set suggests that the handle (b) is provided with a to a hook or clasp formed means (g) in a purpose to be able to securely cooperate with the handle (f), mid-part when a perforated part or recess (c) for the second part is registered with the lid (d) for the vessel (e).

The handle (b) has here been provided a length which only partially allows connection to the length for the handle (f) where these handles are parallely oriented and aligned somewhat upwardly, but separated from each other a distance corresponding to the mean's (g) length.

The means (g) is arranged so that one hand, grasping around the handles (b, f) presses the second unit (a) toward the first units (e) open upper section.

### DESCRIPTION OF THE PRESENTLY-SUGGESTED EMBODIMENT

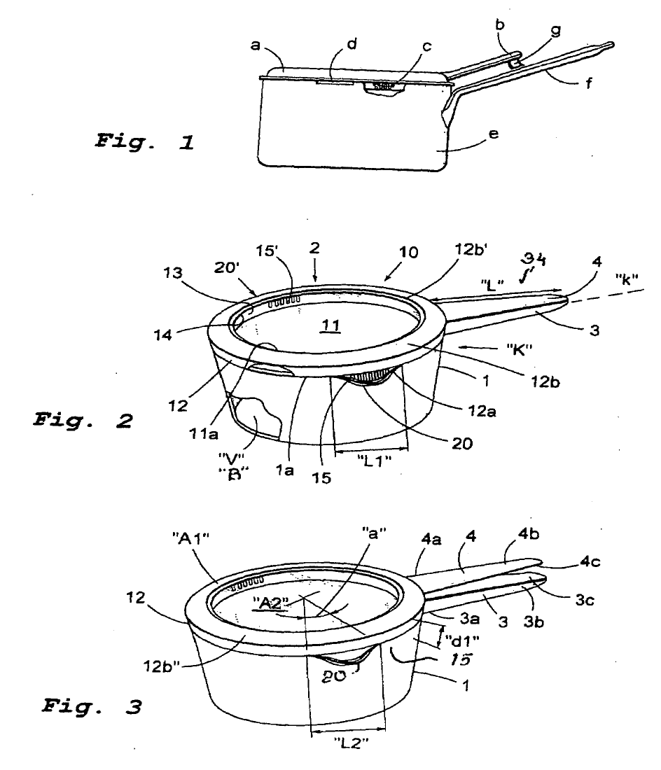

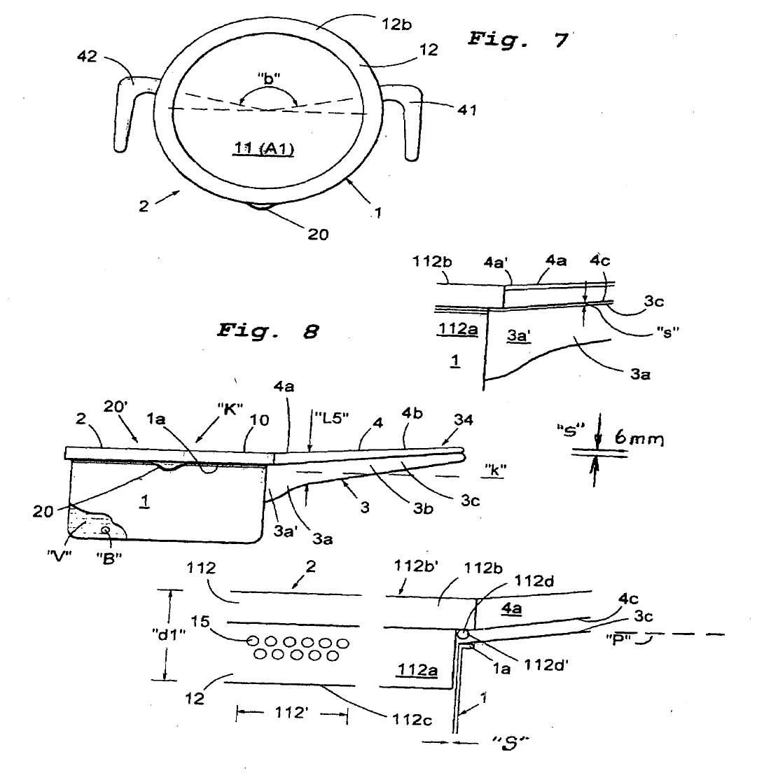

By way of introduction it shall be noted that in the following description of a present embodiment, which shows the significant characteristics associated with the invention and which is clarified through the FIGS. 2 to 8 shown in the following drawings, we have chosen terms and a special terminology with a view to thereby primarily assist in describing the actual inventive idea.

It shall however in this connection be observed that expressions chosen here shall not be seen as limiting solely to the terms used and chosen but rather it shall be understood that each such chosen term shall be interpreted so that it in addition to that can encompass all technical equivalents which function in the same or essentially same way to therewith be able to reach the same or essentially same purpose and/or technical effect.

With a reference to the enclosed FIGS. 2 to 8 it is thus shown schematically and in detail the base conditions for the present invention and where the significant properties connected with the invention are made concrete, through the presently proposed and following more closely described embodiments.

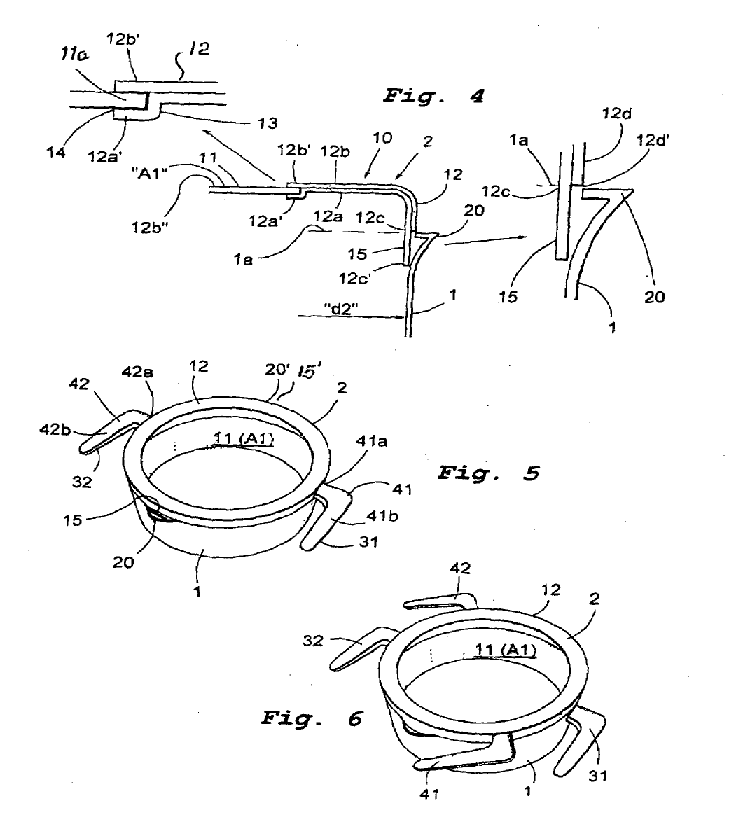

By way of introduction however a proposed lid-like arrangement 10 shall be more closely described, with a direct reference to FIG. 4.

The arrangement 10 is useable with an arrangement detailed first unit 1, such as different kitchen or frying pan sets, and consists of a second unit 2, with a transparent upper part 11 and a upper part's terminally extending rim portion 12, wherein said rim portion 12 is arranged to easily connectably and easily separably be cooperable with an open upper portion for the first unit 1, where the cooperation could be seen as a “light” pressable or for steam under a small lid positive pressure-created “sealing” in the form of a narrow gap.

More specifically said rim portion 12 is formed as two rim portions 12a, 12b easily connectable to one another, in cross-section a right or in this case primarily right angle formed, one inner first rim portion 12a and a further outer second rim portion 12b, integrated or joined in known ways with each other.

Oppositely directed outward surface extensions 12a′, 12b′ for the inner rim portion 12a and the outer rim portion 12b are arranged to support said transparent upper portion 11.

The inner rim portion's 12a oppositely directed outward surface extension 12a′ is formed as a holding organ 12 for said transparent upper portion 11.

The outer rim portion's 12b oppositely directed outward surface extension 12b′ and the inner rim portion's 12a oppositely directed outward surface extension 12a′ form an inward open track 14 provided to the rim, arranged to cooperate with and sup, port a peripheral cant portion 11a, provided to the transparent upper portion 11.

An inner rim portion's 12a downwardly aligned portion 12c shows, in connection to its cant extension 12c′, one or more recesses 15, with a sieve structure.

An outer rim portion's 12b downwardly aligned portion 12d shows a cant extension 12d′, which is useable as a support cant for an open upper portion 1a provided to the first unit 1.

More specially, the transparent upper portion 11 shall be formed of a hardened glass material and in this case one of the two rim portions 12a, 12b shall be formed from a stainless steel material or similar material.

One 15 or two recesses (15, 15′) shall be dimensioned to be able to indicate toward one's or toward each one's provided lip-formed dip 20 or dips (20, 20′) within the first unit's 1 open upper section 1a.

With reference to FIGS. 2 to 8 a pot set “K” useable within a kitchen environment shall now be described.

The pot set “K”, useable within a kitchen environment, involves according to FIGS. 2 to 7 the use of two separate units, although easily connectable with and easily separable from each other, where;
a. a first unit 1m in the form of a pot or the like, is arranged to be able to contain a chosen pourable, such as fluid-like volume “V” with connected parts “B” while,
b. a second unit 2, in the form of a lid or lid like arrangement 10 cooperable with the open upper section 1a of the first unit 1.

Said first unit 1 is provided, in this case, a handle 3, with a handle-related first part 3a, attached to the outside of said first unit 1 and a second part 3b, arranged as a side oriented to said first unit 1, grip-suited and graspable part 3b arranged for one hand's grasp.

Said second unit 2 is provided, in this case, a handle 4, with a handle related first part 4a, attached to the outside of said second unit 2 and a second part 4b, arranged as a side oriented to said second unit, grip-suited and graspable part arranged for one hand's grasp.

Said first unit's I open upper section 1a is provided a, as a lip 20 formed dip or the like, to therewith allow for a controlled passage of the fluid-like volume “V” contained in the first unit via its recess 15, with a rotation around a rotational axis “k” of the first unit 1 and its open upper section 1a with associated applied second unit 2, via its coordinated handles 3, 4 from a horizontal or essentially horizontal position.

The second unit 2 is provided a rim portion 12 extending around with, in this case, a recess 15, provided to said rim portion within a defined portion 112′ thereof, wherein said second unit 2, with its provided rim portion 12 (112) is displaceable or rotatable relative to said first unit 1 and its open upper portion 1a or vice versa, to such a position that the second unit's handle 4 finds itself in a coordinated position with the first unit's 1 handle 1, when said recesses 15, 15′ respectively provided the second unit 2, lead to an indicated position with said dip 20, 20′ respectively, or the like.

The rim 12 provided the second unit 2 is formed as two rim portions 12a, 12b, coordinated with each other, in cross-section to a right angle formed (in FIG. 8 designated 112a, 112b) where an inner first rim portion 12a (112a) is firmed with said recess 15 (recesses) and where an outer second rim portion 12b (112b) is formed with a support cant 12d′ (112d′), arranged for a support to the open upper section 1a provided to the first unit 1, according to the description above in connection to the lid-like arrangement 10, shown in FIG. 4.

According to the present invention the rim 12, with its outer second rim portion 12b, shall be provided a peripheral outward extension “A1” for said upper surface portion 12b″ provided to rim 12 in connection to the second unit's 2 surface extension “A2” falling within a ratio 0.1 to 0.4.

Further, it allows that said recesses 15, 15′ respectively, provided to the second unit 2, are formed exclusively within said inner first rim portion 12a (112a).

The first unit 1 and the second unit 2 are each provided corresponding circular cross-sections and with a suitable measurement which allows that the second unit 2 must be lifted straight up, for an insufficient cooperation with and/or a clamp cooperation with the first unit's 1 open part 1a.

A chosen distance “d1” between the rim's 12b (112b) upper surface “A1” and a lower cant extension 12c (12c′) (112c) for the inner rim portion 12a (112a) is arranged to a value of between 0.1 and 0.3, such as around 0.15, related to a outer diameter “d2” provided to the outer rim portion 12b.

A central oriented plane part provided to the second unit 2, in the form of a class part 11, is attached between said two rim portions 12a, 12b in a collectively-formed holding device.

The handle 3 provided to the first unit 1 and the handle 4 provided to the second unit 2 are here provided the same length “L” and/or corresponding and/or identical forms.

The handle 3 provided to the first unit 1 and the handle 4 provided to the second unit 2 are in a chosen position, according to FIG. 2, in FIG. 5, FIG. 7 and FIG. 8, organised sealingly to one another and therewith create together a grip-suited and graspable cross-section.

The grip-suited and graspable handle's 4 cross section, length and/or shape, with regard in this case the part 4b, shall be dimensioned for their mechanical strains, the grip-suited and graspable handle's 3 cross section, length and/or shape, with regard in this case the part 4a and the part 4b, shall be dimensioned for their mechanical strains, and the grip-suited and graspable handles' 3, 4 connection requires a dimensioning for the total mechanical load.

Therefore each of the cross section, the length, and/or the shape for the coordinated handles 3, 4 (or 3) shall be connected to a more open handle and an increased power effect, even from handicapped people.

The handle 3 provided to or cooperable with the first unit 1 and the handle 4 provided to or cooperable with the second unit 2 therefore show sealing associability with one another, plane or essentially plane surface sections 3c, 4c according to FIG. 3 and FIG. 8.

A length “L1” provided to recess 15, along a cant part 12c for the inner rim portion 12a, and a length “L2” of a lip 20 formed dip, along the open upper section 1a provided to the first unit, are arranged similarly or in this case essentially similarly.

Lengths “L1” or alternatively “L2” are chosen to preferably comprise an angle region “a” of between 30° and 50°.

With reference to the embodiment according to FIGS. 5 to 7 it is illustrated that handles 31, 41 are provided to the first unit 1 while handles 32, 42 are provided to the second unit 2 and provided to an angle formed grip-suited parts 41b, 42b.

More specially a first handle-related first part 41a for a first handle 41 and a second handle-related first part 42a for a second handle 43 are oppositely oriented to said first 1 or to said second 2 unit, respectively.

The opposite orientation is here chosen to connect to the orientation of a chord provided to a circular line, chosen with a circular measure between 160° and 140°, according to FIG. 7 in a direction from an illustrated dip 20.

For handles 31 and 32 provided to the first part 1, the same principles apply as for handles 41 and 42.

FIG. 8 aims to illustrate a third embodiment of a pot set.

Also here is the question of a pot set, useable within a kitchen environment, where this pot set involves the use of two separate units, although easily connectable to and easily separable from one another, where;
a. a first unit 1, in the form of a pot or the like provided with an open upper section, is arranged to be capable of containing an amount of a chosen pourable, such as fluid-like, volume “V” and,
b. a second unit 2, in the form of a lid or a lid-like arrangement cooperable with said first unit's I open upper section 1a, is provided with a circumferential rim or cant to cooperate with said open upper section 1a such that this second unit 2 is rotatably related to said first unit 1 or vice versa in a plane “P” provided to the first unit's 1 open part.

Said first unit 1 is provided, in this case, a handle 3, with a handle-related first part 3a, attached to the outside of said first unit 1, and a second part 3b, arranged as a grip-suited part for one hand's grasp, oriented to the side of said first unit 1.

Said second unit 2 is provided, in this case, a handle 4, with a handle-related first part 4a, attached to the outside of said second unit 2, and a second part 4b, oriented to the side of said second unit 2.

Said first unit's 1 open upper section 1a is provided with a lip formed dip 20 or the like, to therewith allow for a controlled passage of a fluid-like volume “V” contained within the first unit, with a rotation of the first unit 1 and its open upper section 1a with associated applied second unit 2 via their handles 3, 4 from a horizontal or essentially horizontal position around the virtual rotational axis “k”.

The said second unit 2 is provided with an extending around or terminally extending rim 112 with, in this case, a recess 15 provided a defined rim portion 112a or a portion 112′ thereof, wherein said second unit 2, with its provided rim 112, is displaceable or rotatable relative to said first unit 1 and its open upper 1a to and from such a position that the second unit's 2 handle 4 finds itself in a coordinated position with the first unit's 1 handle 3, when said recess 15 provided to the second unit 2 leads to an indicated position with said dip 20 or the like provided to the first unit 1.

Here the embodiment involves that said second part 3b provided to the second unit 2 is arranged as a grip-suited part for one hand's grasp.

In a relatively coordinated rotational position, where said recess 15 leads to an indicated position with said dip 20, the first unit's 1 grip-suited second part 3b leads to a cooperating position with the second unit's 2 grip-suited second part 4b.

Said two second parts 3b, 4b shall here be provided with coordinated lengths so that their free ends connect to, or in this case essentially connect to, each other.

A first surface section 3c provided to the grip-suited second part 3b provided to the first unit 1 shall be arranged to cooperate with and/or sealingly connect itself against a second surface section 4c provided to the grip-suited part 4b of the second unit 2.

Both said second parts 3b, 4b, in a coordinated position, shall together form a graspable handle, where an applied grasping power is arranged to partially bring together partially press said surface sections toward one another via a narrow gap.

Here it is allowed that the second unit's 2 handle related first part 4a, in this case with its fastening to the second unit 2, is provided with a common reinforcement 4a′, where said reinforcement is provided to said first unit's upper portion.

FIG. 8 further allows that said first surface section 3c and said second surface section 4c shall be provided with an angle of between 5 and 15°, such as 6 to 100, and with the surface sections aligned upwardly in connection to a virtual plant “P” oriented within the open upper portion 1a.

Said grip-suited parts should preferably demonstrate a thermal insulating part, such as a silicone part, although not shown.

Said recess 15 provided to the second unit 2 and said dip 20 provided to the first unit 1 are preferably duplicated 15′, 20′, respectively, and directly opposite, or in this case essentially directly oppositely oriented, such as diametrically or in this case essentially diametrically oriented.

A upper support part provided to the first unit 1 in the form of an upper cant 1a shall here be arranged to sealingly support a terminally extending second rim portion 112b provided to the second unit 2, within a rim 112. Nothing excludes the inclusion of a sealing ring 112d′ here.

A first rim portion 112a provided to the second unit 2 is arranged to extend a bit into said first unit 1 and through said open part 1a is arranged to there form a narrow gap “s”, between said first rim portion 112a and an inner surface section for said first unit 1 situated adjacent to said open section 1a.

The gap “s” shall here be associated with an opening of 1 to 2 mm to form a “sealing” against forming steam, so that steam at first passes the recesses 15, 15′ respectively via dips 20, 20′ respectively.

A cross sectional surface formed between a free cant 112c provided to said second rim portion and a cant oriented adjacent to the first unit is arranged to somewhat extend over a cross sectional surface provided to the open section 1a.

Said recess or recesses 15, 15′ respectively are provided to said first rim portion 112a and leave a portion 112e of the rim portion 112a adjacent to its free cant 112c, where this part is arranged for an orientation under said dip 20 for a sealing, via a narrow gap “s”, toward an inner surface section for said first unit 1.

The rim 112 provided to said second unit 2 is formed as two rim portions 112a, 112b cooperable with one another, right angle or essentially right angle-formed in cross section, where an inner first rim portion 112a and is formed with said recess (recesses 15, 15′) and where an outer second rim portion 112b is formed with a support cant 112d, arranged for support to the open upper section 1a provided to the first unit 1.

The rim 112, with its outer rim portion, is provided with a peripheral outward extension for said upper surface portion provided to the rim in relation to the second unit's surface extension falling within a ratio 0.1 to 0.4.

Said recess 15 provided to the second unit 2 shall be formed exclusively within and surrounded by said inner first part 112a.

The first unit 1 and the second unit 2 shall preferably each be provided corresponding circular cross sections according to known principles.

A chosen distance “d1” between the outer rim portion's 112b upper surface 112b′ and a lower cant extension 112c for the inner rim portion 112a, can be arranged to be related to the outer diameter provided to the outer rim portion 112b with a value of between 0.1 and 0.2, such as about 0.15.

The handle 3 provided to the first unit 1 and the handle 4 provided to the second unit 2 are provided the same length and/or show an outwardly converging three dimensional form and corresponding forms for one hand's grasp.

The handle provided to or associated with the first unit and the handle provided to or associated with the second unit shall show toward one another closely associable plane or essentially plane and similar surface extensions provided to surface sections 3c, 4c.

A length provided to the recess, along a cant portion for the inner rim portion, and a lip-formed dip's provided length, along the first unit's open upper section, shall preferable be arranged similarly.

Said handles, provided to the first unit and the second unit, are provided a grip-suited part formed at a small angle.

More particularly the first unit's 1 first 3a and second 3b parts show an outwardly aligned converging form, with a convergence of between (1-3):30, such as about 1:20.

The second unit's 2 first 4a and second 4b parts show an outwardly aligned converging form, with a convergence of between (1-3):30, such as about 1:20.

FIG. 8 allows illustration of the first unit's 1 first part 3a showing an underlying reinforcement 3a′.

The first unit's 1 transition between its reinforcement 3a′ and/or first part 3a and its second part 3b and the second unit's 2 transition between its reinforcement 4a′ and/or second part 4a and its second part 4b show a thickness ratio of between (2.5-1-5):1, such as preferably 2:1.

This cut line is illustrated as a line “L5”.

The invention is of course not limited to the above such as exemplary given embodiments but instead can go through modifications within the limits for the inventive though illustrated in the following patent claims.

It should particularly be considered that each displayed unit and/or set can be combined with each other displayed unit and/or set within the limits for being able to reach the desired technical function.

1-34. (canceled)

35. A pot set for use in a kitchen environment, comprising:
a first unit, in the form of a pot, capable of containing an amount of a liquid having viscous properties and in the form of a pourable volume, comprising:
an open upper section, which comprises a dip, allowing a controlled passage of said pourable volume contained within the first unit, and
a first handle arrangement comprising:
a first handle section related first part attached to the outside of said first unit, and
a first handle section related second part, oriented aside said first unit, arranged as a grippable form adapted for a single hand's grasp, and having a first surface section,
a second unit, in the form of a lid cooperable with said open upper section of the first unit, comprising:
a circumferential cant,
a rim extending around the second unit, and
a second handle arrangement, comprising:
a second handle section related first part attached to the outside of the second unit, and
a second handle section related second part, oriented aside said second unit, arranged as a grippable form adapted for a single hand's grasp, and having a first surface section,
wherein
said first unit and said second unit are easily connectable and separable from one another,
the first unit and the second unit are displaceable relative to one another and are rotatably related to one another in a plane of the units,
a pourable volume, contained within the first unit, can be poured out of said first unit by rotating the first unit and its associated second unit from a substantially horizontal position, via a rotational movement of the first handle section and the second handle section,
the dip of the first unit and a recess of the second unit are arranged in an aligned position when the first unit handle section and the second unit handle section and its related second part are in an aligned position,
the first handle section and second handle section are provided coordinated lengths, when the first unit and the second unit are in a coordinated relative rotational position the second unit recess leads to a position with the first unit dip and the first handle related second part leads to a coordinated position with the second handle related second part,
the first surface section of the first handle related second part is cooperable with the first surface section of the second handle related second part and when a grasping power is applied by a hand and the power brings together at least a part of the first surface section of the first handle related second part and the first surface section of the second handle related second part so the two handle arrangements together form a graspable handle.

36. A pot set according to claim 35, wherein the second handle's first part is provided with reinforcement at its connection to the second unit.

37. A pot set according to claim 36, wherein said reinforcement is provided to an upper section of the second handle related first part.

38. A pot set according to claim 35, wherein the first surface section of the first handle related second part and the first surface section of the second handle related second part are allocated an angle of between 5 and 15° upwardly in relation to a plane relative to the open upper section.

39. A pot set according to claim 35, wherein said grippable form adapted parts comprise a heat insulating section.

40. A pot set according to claim 35, wherein the first unit comprises two diametrically opposed dips and the second unit comprises two diametrically opposed recesses.

41. A pot set according to claim 35, wherein the first unit further comprises an upper support part to sealingly support the rim of the second unit.

42. A pot set according to claim 35, wherein the rim of the second unit can extend through the open upper section and a portion of the way into the first unit and can create a narrow gap between the rim and an inner surface section of the first unit located adjacent to and within the open upper section.

43. A pot set according to claim 35, wherein a cross-sectional surface, created between a free cant on the second unit and a cant along the first unit extends somewhat over a cross-sectional surface provided to the open upper section.

44. A pot set according to claim 35, wherein said recess or recesses leave at least a part of the rim portion under the dip undeformed to provide a narrow gap for sealing the second unit against an inner surface section of the first unit.

45. A pot set according to claim 35, wherein
the rim comprises two cooperating parts essentially right-angled in cross-section,
an inner rim portion comprises the recess or recesses, and
an outer rim portion comprises the cant arranged as a support against the open upper section of the first unit.

46. A pot set according to claim 45, wherein the upper surface portion of the rim comprises a circumferential outward extension which bears a ratio to a surface extension of the second unit of 0.1 to 0.4.

47. A pot set according to claim 45, wherein the recess is exclusively formed within and surrounded by the inner rim portion.

48. A pot set according to claim 35, wherein the first unit and the second unit comprise corresponding circular cross-sections.

49. A pot set according to claim 48, wherein a distance between the upper surface of the outer rim and a lower outward extension of the inner rim bears a ratio to an outer diameter of the outer rim portion of between 0.1 and 0.2.

50. A pot set according to claim 48, wherein a centrally located horizontal glass part for the second unit is attached or pressed between the two rim portions.

51. A pot set according to claim 35, wherein the recess and an inner portion of the second unit are formed as a sieve structure.

52. A pot set according to claim 35, wherein the first handle and the second handle are the same length and/or are comprise outwardly converging form, adapted for a grip of a single hand.

53. A pot set according to claim 35, wherein the first handle and the second handle comprise respective first surface sections which are essentially level and equal with one another.

54. A pot set according to claim 45, wherein
the recess along the cant of the inner rim comprises a recess length
the dip along the open upper section of the first unit comprises a dip length, and
the recess length is similar to the dip length.

55. A pot set according to claim 35, wherein each of the first handle and the second handle comprise slightly angular graspable parts.

56. A pot set according to claim 55, wherein
first handle related parts are oriented opposite to the first unit, and
second handle related parts are oriented opposite to the second unit.

57. A pot set according to claim 56, wherein opposite orientation relates to a chord location provided with a circular line chosen with a circular measure between 160° and 140°.

58. A pot set according to claim 35, wherein
the first handle related first part and the first handle related second part comprise outwardly-aligned convergent forms, and
the convergence is between (1-3):30.

59. A pot set according to claim 35, wherein
the second handle related first part and the second handle related second part comprise outwardly-aligned convergent forms, and
the convergence is between (1-3):30.

60. A pot set according to claim 35, wherein
the first handle related first part comprises an underlying reinforcement, and
the second handle related first part comprises an underlying reinforcement.

61. A pot set according to claim 60, wherein
a transition between the first handle related first part reinforcement and the first handle related second part has a thickness ratio of between (2.5-1.5):1, and
a transition between the second handle related first part reinforcement and the second handle related second part has a thickness ratio of between (2.5-1.5):1.

62. A lid-like arrangement, comprising:
a transparent upper portion, and
a rim portion extending around the upper portion, comprising:
an inner rim portion, essentially right angle-formed in cross section, and having an outward surface extension, and
an outer rim portion, essentially right angle-formed in cross section, and cooperable with the inner rim portion and having an outward surface extension,
wherein
the rim portion is easily connectable to and separable from an open upper section of a first unit of a pot set,
the inner rim and the outer rim are aligned with and/or joined to one another, and
the outward surface extension of the inner rim and the outer surface extension of the outer rim support the transparent upper portion.

63. A lid-like arrangement according to claim 62, wherein the outward surface extension of the inner rim portion comprises a holding device for the transparent upper portion.

64. A lid-like arrangement according to claim 62, wherein
the transparent upper portion comprises a circumferential cant,
the outward surface extension of the outer rim portion and the outward surface extension of the inner rim portion form a groove, and
the groove is arranged to cooperate with and support the circumferential cant.

65. A lid-like arrangement according to claim 62, wherein
the inner rim portion has a downward section, and
the downward section of the inner rim portion has at least one recess comprising a sieve structure in connection to the outward surface extension of the inner rim portion.

66. A lid-like arrangement according to claim 62, wherein
the outer rim portion has a downward section,
the downward section of the outer rim portion has an outward extension useable as a support for the open upper section of the first unit.

67. A lid-like arrangement according to claim 62, wherein
the transparent upper portion comprises hardened glass material, and
the two rim portions comprise stainless steel material or the like.

68. A lid-like arrangement according to claim 65, wherein the at least one recess can indicate toward dips within the open upper section of the first unit.
